(19) United States
(12) Patent Application Publication
(10) Pub. No.: US 2024/0030543 A1
(43) Pub. Date: Jan. 25, 2024

(54) BATTERY PACK, ELECTRONIC DEVICE, AND BATTERY PACK PRODUCTION METHOD

(71) Applicant: Panasonic Intellectual Property Management Co., Ltd., Osaka (JP)

(72) Inventors: Takamasa HIRANO, Osaka (JP); Shintarou TANAKA, Osaka (JP); Junichi HASEGAWA, Osaka (JP); Junpei KOHARA, Osaka (JP); Hiroki KAMEZAKI, Osaka (JP)

(73) Assignee: Panasonic Intellectual Property Management Co., Ltd., Osaka (JP)

(21) Appl. No.: 18/375,531

(22) Filed: Oct. 1, 2023

Related U.S. Application Data
(63) Continuation of application No. PCT/JP2022/014374, filed on Mar. 25, 2022.

(30) Foreign Application Priority Data
Apr. 15, 2021 (JP) 2021-069181

(51) Int. Cl. H01M 50/293; H01M 50/211; H01M 50/244

(52) U.S. Cl. CPC H01M 50/293; H01M 50/211; H01M 50/244; H01M 2220/30; H01M 50/242

(57) ABSTRACT

A battery pack includes: a battery case; a battery that is housed in the battery case and configured of a pouch type cell having a first plane and a second plane disposed on an opposite side of the first plane; and an adhesive layer that is arranged between at least one of the first plane and the second plane of the battery and an inner surface of the battery case in a shape of a frame along an outer edge of the battery.

### BACKGROUND

### 1. Technical Field

The present invention relates to a battery pack, an electronic device, and a method of producing the battery pack.

### 2. Description of the Related Art

Patent Literature (PTL) 1 and PTL 2 disclose battery packs in which a battery is bonded to a pack case with a double-sided tape.

PTL 1 is Japanese Translation of PCT International Application No. 2013-530498. PTL 2 is Japanese Translation of PCT International Application No. 2008-529237.

### SUMMARY

However, in the battery packs described in PTL 1 and PTL 2, there is room for progress in terms of quality improvement.

An object of the present disclosure is to provide a battery pack, an electronic device, and a method of producing the battery pack capable of improving quality.

A battery pack according to one aspect of the present disclosure includes: a battery case; a battery that is housed in the battery case and configured of a pouch type cell having a first plane and a second plane disposed on an opposite side of the first plane; and an adhesive layer that is arranged between at least one of the first plane and the second plane of the battery and an inner surface of the battery case in a shape of a frame along an outer edge of the battery.

An electronic device according to one aspect of the present disclosure includes a battery pack that includes: a battery case; a battery that is housed in the battery case and configured of a pouch type cell having a first plane and a second plane disposed on an opposite side of the first plane; and an adhesive layer that is arranged between at least one of the first plane and the second plane of the battery and an inner surface of the battery case in a shape of a frame along an outer edge of the battery.

A method of producing a battery pack according to one aspect of the present disclosure includes the steps of: mounting a battery to a bottom case; arranging a buffer material on a top surface of the battery, and applying an adhesive in a shape of a frame along an outer edge of the buffer material; and mounting a top case to the bottom case, and bonding the top case to the bottom case by the adhesive to form an adhesive layer.

According to the present disclosure, quality can be improved.

### BRIEF DESCRIPTION OF THE DRAWINGS

FIG. 1 is a perspective view illustrating an example of an electronic device according to an exemplary embodiment of the present disclosure.

FIG. 2 is a perspective view of the electronic device in FIG. 1 as viewed from a bottom surface side.

FIG. 3 is a perspective view of a battery pack of the exemplary embodiment.

FIG. 4 is a perspective view illustrating a state in which a top case of the battery pack in FIG. 3 is removed.

FIG. 5 is a perspective view illustrating the state before a buffer material and an adhesive layer are formed on one battery of the battery pack in FIG. 4.

FIG. 6 is a perspective view illustrating the state before one battery is mounted to the battery pack in FIG. 5.

FIG. 7 is a cross-sectional view of the battery pack taken along line VII-VII illustrated in FIG. 3.

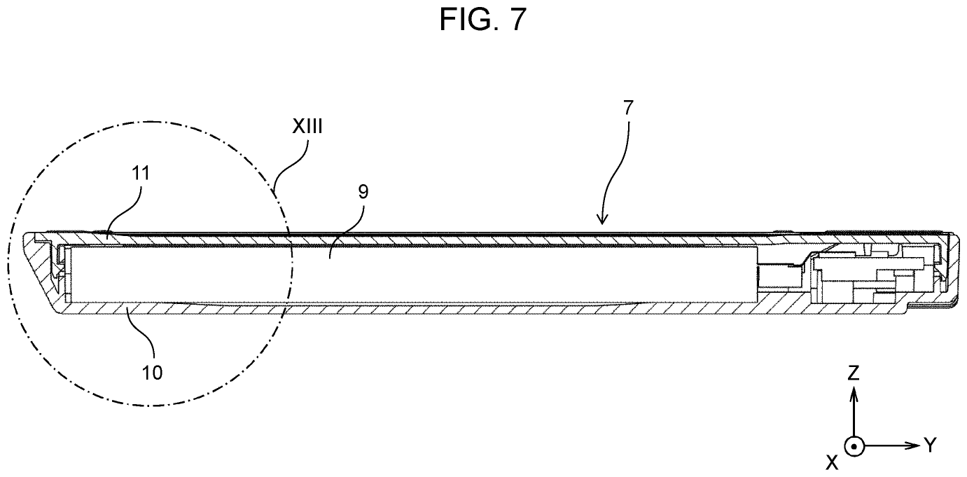

FIG. 8 is a partially enlarged view of a portion VIII illustrated in FIG. 7.

### DETAILED DESCRIPTION

### Background to Present Disclosure

Examples of an electronic device include a notebook computer (laptop PC). The notebook computer includes a first housing having a display, a second housing having an input unit, and a hinge rotatably connecting the first housing and the second housing. In addition, the notebook computer is provided with a battery pack on the second housing side.

Although a rectangular cell has been used for the conventional battery pack, a pouch type cell, which is small and lightweight and can be used for a long time, has been used instead in recent years. The pouch type cell is covered with a film and is vulnerable to an external impact. Therefore, a cushion material is disposed between a battery and a battery case in order to protect the battery when an impact force acts on the battery pack.

However, the cushion material having high rigidity inevitably causes variations in manufacturing dimensions. Therefore, since a smaller thickness than the design value causes a gap between the battery and the battery case at the time of assembly, the cushion material may not be able to absorb the impact force. Conversely, since a larger thickness than the design value causes an excessive load applied to the battery, which is further exacerbated by thermal expansion at the time of use, a structure becomes vulnerable to the impact force. On the other hand, the cushion material having low rigidity cannot protect the battery against the external impact force effectively.

The present inventors have found that an adhesive layer disposed partially enables to hold the battery in a good state even in a case of the pouch type cell that cannot be sufficiently protected by the cushion material, and disclose the findings as follows.

A battery pack according to a first aspect of the present disclosure includes: a battery case; a battery that is housed in the battery case and configured of a pouch type cell having a first plane and a second plane disposed on an opposite side of the first plane; and an adhesive layer that is arranged between at least one of the first plane and the second plane of the battery and an inner surface of the battery case in a shape of a frame along an outer edge of the battery.

In this configuration, since the adhesive layer is provided between the battery and the battery case, the battery and the battery case can be disposed and held without a gap. Even if an impact force acts from an outside, this impact force can be effectively absorbed by the adhesive layer. In addition, since the adhesive layer is partially provided in a frame shape, even if the battery is expanded due to heat generated at a time of use, a problem such as a pressure contact of the battery with the battery case is prevented.

In a battery pack according to a second aspect of the present disclosure, the inner surface of the battery case may include a first inner surface facing the first plane and a second inner surface facing the second plane, the adhesive layer may be arranged on the first plane and the second plane of the battery, the first inner surface of the battery case and the first plane of the battery may be fixed with each other by a double-sided tape disposed on an inner side of the adhesive layer, and a distance between the second inner surface of the battery case and the second plane of the battery may be larger than the distance between the first inner surface of the battery case and the first plane of the battery.

In this configuration, the battery expands on the second plane side that is not fixed by the double-sided tape when heat generated at a time of use. Then, since the distance between the battery and the second inner surface of the battery case is large on the second plane side where the battery expands, the battery can avoid a contact with the battery case.

In a battery pack according to a third aspect of the present disclosure, the adhesive layer may have a maximum tensile stress of 2 N/m² or more and 5 N/m² or less.

In this configuration, since the impact force acting from the outside can be appropriately absorbed by the adhesive layer, the damage of the battery can be effectively prevented.

In a battery pack according to a fourth aspect of the present disclosure, the adhesive layer may have a width dimension of 0.5 mm or more and 10 mm or less.

In a battery pack according to a fifth aspect of the present disclosure, the second plane of the battery may be provided with a buffer material having a smaller elastic coefficient than the adhesive layer.

In this configuration, even if the battery case is deformed, the battery at least avoid the damage by abutting on the battery case due to presence of the buffer material.

In a battery pack according to a sixth aspect of the present disclosure, the buffer material may be disposed along an inner side of the adhesive layer, and a gap may be provided between the buffer material and the second inner surface of the battery case.

In this configuration, even if the battery expands due to heat generated at the time of use, the problem caused by a pressure contact force applied to the battery is prevented because of the gap between the buffer material and the inner surface of the battery case and the presence of the buffer material.

An electronic device according to a seventh aspect of the present disclosure includes a battery pack that includes: a battery case; a battery that is housed in the battery case and configured of a pouch type cell having a first plane and a second plane disposed on an opposite side of the first plane; and an adhesive layer that is arranged between at least one of the first plane and the second plane of the battery and an inner surface of the battery case in a shape of a frame along an outer edge of the battery.

In this configuration, even if the impact force acts from the outside, since this impact force can be effectively absorbed by the adhesive layer between the battery and the battery case, the damage to the battery can be prevented. In addition, since the adhesive layer is partially provided in a frame shape, even if the battery is expanded due to heat generated at a time of use, a problem such as a pressure contact of the battery with the battery case is prevented.

A method of producing a battery pack according to an eighth aspect of the present disclosure includes the steps of: mounting a battery to a bottom case; arranging a buffer material on a top surface of the battery, and applying an adhesive in a shape of a frame along an outer edge of the buffer material; and mounting a top case to the bottom case, and bonding the top case to the bottom case by the adhesive to form an adhesive layer.

In this method, since the adhesive is applied to only in the frame shape, an amount of the adhesive to be used can be suppressed.

### EXEMPLARY EMBODIMENT

### General Configuration

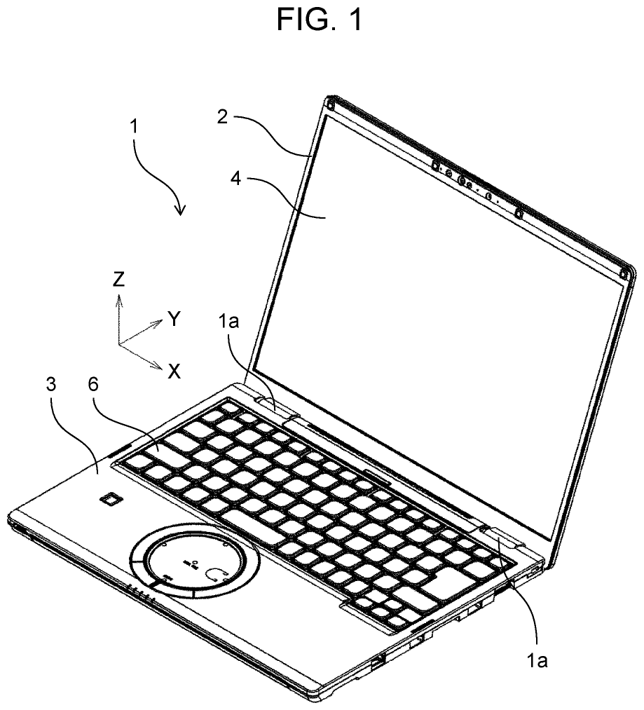

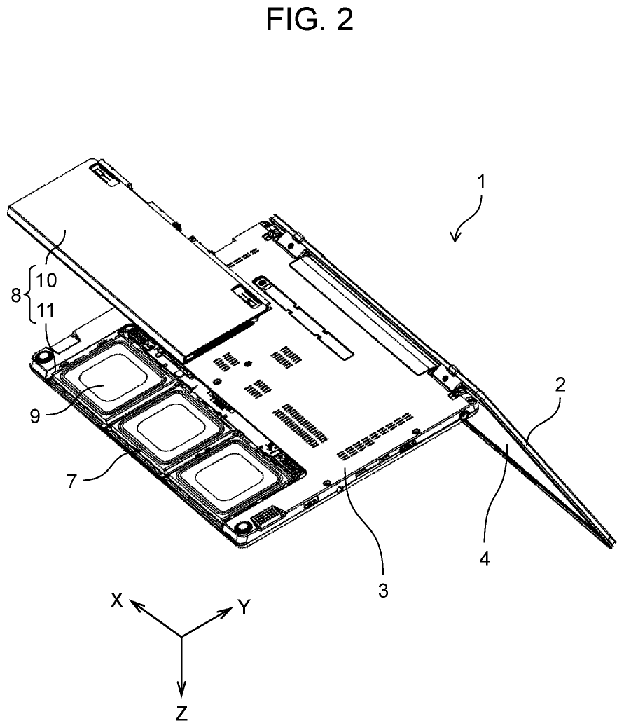

FIG. 1 is a schematic perspective view illustrating an example of electronic device 1 according to an exemplary embodiment of the present disclosure. FIG. 2 is a schematic perspective view illustrating a state where bottom case 10 described later is removed when electronic device 1 in FIG. 1 is viewed from a bottom surface side. In the drawings, X, Y, and Z directions respectively indicate a width direction, a depth direction, and a height direction of electronic device 1.

Electronic device 1 includes first housing 2 and second housing 3, and first housing 2 and second housing 3 are rotatably connected via hinge 1a. First housing 2 and second housing 3 have a thin box shape having a rectangular shape in a planar view.

Liquid crystal panel 4 is housed in first housing 2 as a display. Battery pack 7 is housed in second housing 3 in addition to keyboard 5 and touch pad 6. Hereinafter, battery pack 7, which is a characteristic part of the present disclosure, will be described in detail.

[Battery Pack]

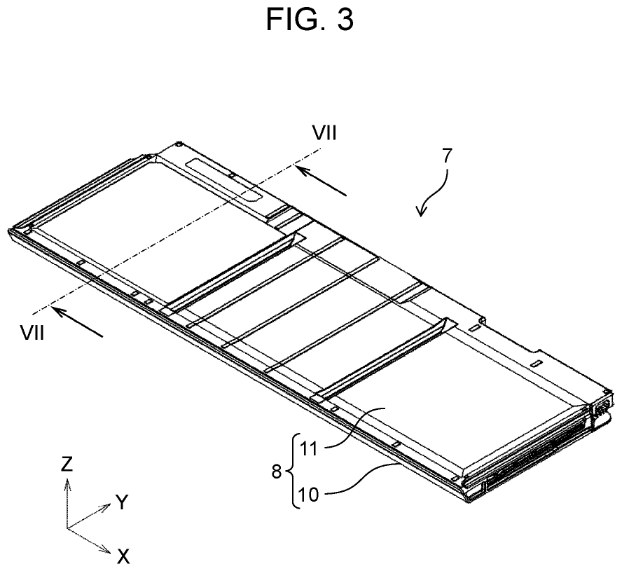

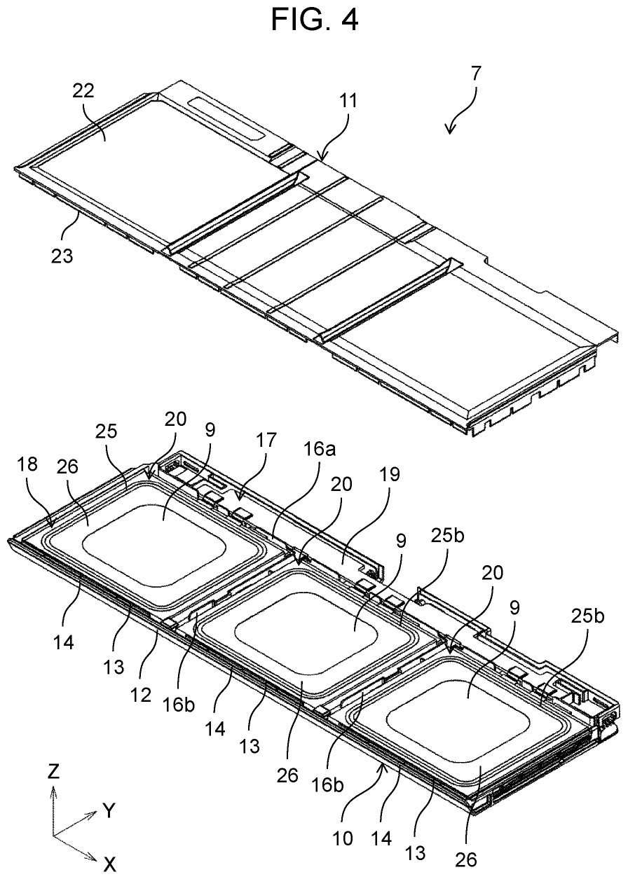

As illustrated in FIGS. 3 and 4 (A vertical direction (Z direction) is reversed from that in FIG. 2.), battery pack 7 includes battery case 8 and battery 9 housed in battery case 8. Battery pack 7 is housed on a front side in a depth direction of a bottom surface of second housing 3.

Battery case 8 includes bottom case 10 and top case 11 made of a synthetic resin material.

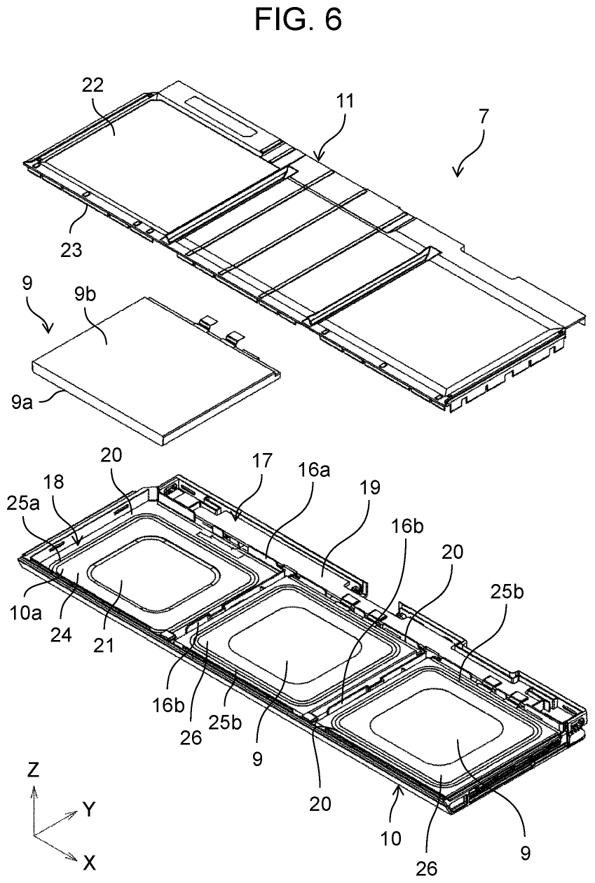

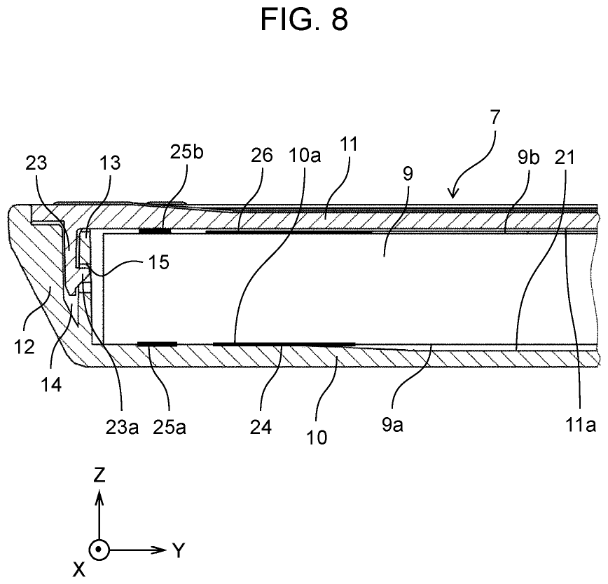

Bottom case 10 has the rectangular shape in the planar view, and guide walls 13 are formed inward along side wall 12 at predetermined intervals as illustrated in FIG. 4. Locking wall 23 of top case 11 described later is inserted into locking groove 14 formed between side wall 12 and guide wall 13. Locking holes 15 (see FIG. 8) are formed at a plurality of places in guide wall 13. Bottom case 10 is divided into two in a lateral direction by partition wall 16a, one of which is board container 17 and another is battery container 18. Power supply board 19 on which various electronic components are mounted is screwed and fixed to board container 17. Battery container 18 is further divided in a longitudinal direction by two partition walls 16b, and three container recesses 20 are formed. Battery 9 is housed in each container recess 20. Recess 21 (see FIG. 6) having the rectangular shape in the planar view is formed in a central portion of the bottom surface of each container recess 20. This recess 21 prevents battery 9 from coming into pressure contact with bottom case 10 even if battery 9 is thermally expanded during use. Electrodes extending from respective batteries 9 are electrically connected at predetermined positions on power supply board 19.

As illustrated in FIG. 4, top case 11 includes plate 22 having the rectangular shape in the planar view and locking wall 23 protruding at a substantially right angle from an inner portion of plate 22 along an outer edge of plate 22. A lower surface of plate 22 (ceiling surface of top case 11) is a flat surface without a recess. Locking claws 23a (see FIG. 8), which can be engagingly locked to respective locking holes 15 formed in guide wall 13 of bottom case 10, are formed on a lower end side inner surface of locking wall 23.

As illustrated in FIG. 6, battery 9 is configured of a rechargeable pouch type cell including first plane 9a having a substantially square shape in the planar view and second plane 9b opposite to first plane 9a. Specifically, first plane 9a and second plane 9b are in a positional relationship of facing each other, that is, in a relationship of overlapping each other in the planar view.

As illustrated in FIG. 6, double-sided tape 24 and adhesive layer 25a are provided between battery 9 and bottom case 10. Double-sided tape 24 has a rectangular frame shape in the planar view disposed so as to surround recess 21 formed on the bottom surface of battery container 18. Double-sided tape 24 fixes first plane 9a (lower surface) of battery 9 to first inner surface 10a (bottom surface) of bottom case 10. Adhesive layer 25a is formed in the rectangular frame shape in the planar view along the outer edge of first plane 9a of the battery 9, and bonds first plane 9a of battery 9 to first inner surface 10a of bottom case 10. An elastic coefficient of adhesive layer 25a is larger than an elastic coefficient of double-sided tape 24. A width dimension of adhesive layer 25a is in a range of 0.5 mm or more and 10 mm or less. Battery 9 can be supported by bottom case 10 in a stable condition when the width dimension of adhesive layer 25a is set within the above range.

Buffer material 26 and adhesive layer 25b are provided between battery 9 and top case 11. One surface (lower surface) of buffer material 26 is attached to second plane 9b (upper surface) of battery 9 with a double-sided tape or the like. A gap is formed between remaining one surface (upper surface) of buffer material 26 and second inner surface 11a of top case 11. As a result, even if battery 9 thermally expands during use, an amount of deformation of battery 9 can be sufficiently absorbed by the gap and an elastic deformation of buffer material 26.

Adhesive layer 25b is formed by solidifying the applied adhesive. Regarding the adhesive to be used, the adhesive having an elastic coefficient after solidification smaller than that of buffer material 26 and larger than that of double-sided tape 24 can be used. As a result, even if battery 9 is thermally expanded due to heat generated at the time of use, since adhesive layer 25b is elastically deformed, an excessive force acting on battery 9, etc. to cause a damage can be prevented. As the adhesive, for example, a silicon-based adhesive (such as a silicon-modified polymer adhesive), which provides adhesive layer 25b with a maximum tensile stress of 2 N/m² or more and 5 N/m² or less, is used. By setting the maximum tensile stress within this range, even if an impact force acts, the impact force can be sufficiently absorbed by adhesive layer 25b. The elastic coefficient and the maximum tensile stress of adhesive layer 25b can be freely set by mixing a plurality of types of adhesives and adjusting the blending ratio of them. As the adhesive, the adhesive providing adhesive layer 25b with a thermal conductivity of 0.5 W/(m·K) or more can be used. By setting the thermal conductivity to 0.5 W/(m·K) or more, heat generated when battery 9 is used can be released to battery case 8. In addition, since the adhesive has sufficient flexibility when applied, it is possible to bond battery 9 to battery case 8 while maintaining appropriate elasticity so as not to generate the gap between battery 9 and battery case 8. Furthermore, the width dimension of the adhesive layer 25b is in the range of 0.5 mm or more and 10 mm or less. By setting the width dimension of the adhesive layer 25b within this range, the supporting condition of battery 9 can be stabilized, and the impact due to the external force can be sufficiently absorbed to prevent battery 9 from being damaged.

[Assembly Work of Battery Pack]

Battery pack 7 described in the above configuration is assembled as follows.

Double-sided tape 24 having the rectangular frame shape is attached to the bottom surface of each container recess 20 of battery container 18 in bottom case 10 so as to surround recess 21 (see container recess 20 in a −X direction in FIG. 6). Furthermore, the adhesive is supplied in the rectangular frame shape along a periphery of attached double-sided tape 24 through a nozzle moved by a robot arm. The adhesive is applied so as to be slightly higher than the thickness dimension of attached double-sided tape 24.

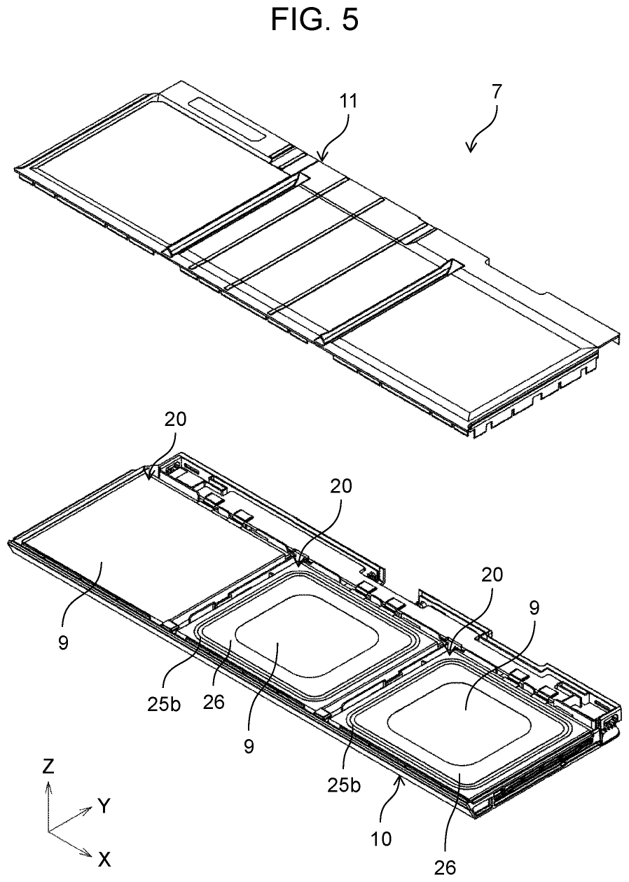

Next, battery 9 is mounted in each container recess 20 in battery container 18 of bottom case 10 (see container recess 20 in the −X direction in FIG. 5). Battery 9 is fixed to bottom case 10 by double-sided tape 24. At this time, battery 9 is bonded by the adhesive around double-sided tape 24, and adhesive layer 25a is formed by the cured adhesive. Adhesive layer 25a has the larger elastic coefficient than double-sided tape 24, and functions to absorb the impact force when the impact force acts from the outside.

Next, buffer material 26 is attached to the upper surface of battery 9 on battery container 18 with the double-sided tape (see container recess 20 at a center in the X direction and in a +X direction in FIG. 5). Buffer material 26 has the rectangular shape in the planar view having a rectangular through hole for avoiding to overlap the central portion of battery 9. This enables to prevent an interference at the central portion where battery 9 expands most due to the thermal expansion during use.

Furthermore, the adhesive for forming adhesive layer 25b is supplied through the nozzle moved along the outer edge of buffer material 26 by the robot arm. The supplied adhesive is applied along the outer edge of battery 9. Specifically, an applied position is located in a predetermined dimension inside from the outer edge of battery 9.

Although the adhesive is applied so as to be slightly higher than the thickness of double-sided tape 24 on bottom case 10 side, the adhesive is applied so as to be further higher than the thickness of the double-sided tape when the adhesive is supplied to the upper surface of battery 9. The application amount of the adhesive supplied through the nozzle is adjusted so as to be in the range of 0.1 ml or more and 0.5 ml or less for battery 9 (per one cell). The height of the applied adhesive from the upper surface of the battery 9 is adjusted to be in the range of, for example, 0.25 mm or more and 0.8 mm or less.

After the adhesive is applied to the upper surface of battery 9, top case 11 is mounted to bottom case 10 as illustrated in FIG. 3. Top case 11 is mounted by inserting locking wall 23 into locking groove 14 of bottom case 10 and engagingly locking locking claw 23a to locking hole 15. At this time, the adhesive applied to the upper surface of battery 9 is pressed by second inner surface 11a of top case 11 to bond battery 9 and top case 11 to each other. Since the adhesive is soft at the time of bonding, battery 9 and top case 11 can be reliably bonded by simply mounting top case 11 to bottom case 10.

After top case 11 is mounted to bottom case 10, the adhesive applied to the upper surface of battery 9 is cured to form adhesive layer 25b having a predetermined maximum tensile stress. Therefore, even if the impact force acts from the outside, adhesive layer 25b functions as the buffer material that absorbs the impact force to prevent battery 9 from the damage. Furthermore, a distance between the upper surface (second plane) of battery 9 and the ceiling surface (second inner surface) of top case 11 is sufficiently larger than the distance between the lower surface (first plane) of battery 9 and the bottom surface (first inner surface) of bottom case 10. For example, the distance between the upper surface of battery 9 and the ceiling surface of top case 11 can be set to the distance of 0.2 mm or more and 0.4 mm or less (here, 0.23 mm). Therefore, even if battery 9 generates heat during use and the central portion thermally expands, battery 9 does not touch the ceiling surface of top case 11.

[Effects]

Battery pack 7 mounted on electronic device 1 according to the exemplary embodiment provides the following effects.

Since adhesive layers 25a and 25b are formed by curing the applied adhesive, the adhesive layers are reliably disposed between battery 9 and battery case 8 without any gap.

Even if battery pack 7 is gripped with a hand, it is hardly deformed due to presence of adhesive layers 25a and 25b.

Even if the impact force acts by falling or the like, the impact force can be absorbed to prevent battery 9 from being damaged due to the presence of adhesive layers 25a and 25b.

Since adhesive layers 25a and 25b are disposed in the frame shape along the outer edge of battery 9, it is possible to secure a space for deformation even if battery 9 expands due to heat generation during use while suppressing the amount of adhesive to be used.

The heat generated from battery 9 can be released from battery case 8 to the outside due to the presence of adhesive layers 25a and 25b.

### Other Exemplary Embodiments

Although adhesive layers 25a and 25b are respectively disposed between first plane 9a of battery 9 and first inner surface 10a of bottom case 10 and between second plane 9b of battery 9 and second inner surface 11a of top case 11 in the above exemplary embodiment, only one of them may be disposed.

Although double-sided tape 24 is disposed between first plane 9a of battery 9 and first inner surface 10a of bottom case 10, and buffer material 26 is disposed between second plane 9b of battery 9 and second inner surface 11a of top case 11 in the above exemplary embodiment, these are not necessarily required. In addition, double-sided tape 24 and buffer material 26 are not limited to the rectangular frame shape.

Although adhesive layer 25a disposed between bottom case 10 and battery 9 and adhesive layer 25b disposed between top case 11 and battery 9 are formed of a same type of adhesive in the above exemplary embodiment, different types of adhesive may be used. For example, the elastic coefficient of the adhesive forming adhesive layer 25b can be made larger than that of adhesive layer 25a.

Although the present disclosure has been fully described in relation with a preferred exemplary embodiment with reference to the accompanying drawings, various modifications and corrections are obvious to those who are skilled in this technique. It should be understood that, as long as such modifications and corrections do not deviate from the scope of the present disclosure according to the appended claims, such modifications and corrections are included therein.

Since the battery pack of the present disclosure is excellent in impact resistance, the battery pack is useful for mounting on electronic devices including notebook computers.

What is claimed is:

1. A battery pack comprising:
a battery case;
a battery housed in the battery case, the battery being configured of a pouch type cell having a first plane and a second plane disposed on an opposite side of the first plane; and
an adhesive layer arranged between at least one of the first plane and the second plane of the battery and an inner surface of the battery case, the adhesive layer being arranged in a shape of a frame along an outer edge of the battery.

2. The battery pack according to claim 1, wherein the inner surface of the battery case includes a first inner surface facing the first plane and a second inner surface facing the second plane,
the adhesive layer is arranged on the first plane and the second plane of the battery,
the first inner surface of the battery case and the first plane of the battery are fixed with each other by a double-sided tape disposed on an inner side of the adhesive layer, and
a distance between the second inner surface of the battery case and the second plane of the battery is larger than a distance between the first inner surface of the battery case and the first plane of the battery.

3. The battery pack according to claim 1, wherein the adhesive layer has a maximum tensile stress of 2 N/m² or more and 5 N/m² or less.

4. The battery pack according to claim 1, wherein the adhesive layer has a width dimension of 0.5 mm or more and 10 mm or less.

5. The battery pack according to claim 1, wherein the second plane of the battery includes a buffer material having a smaller elastic coefficient than the adhesive layer.

6. The battery pack according to claim 5, wherein the buffer material is disposed along an inner side of the adhesive layer, and a gap is provided between the buffer material and the second inner surface of the battery case.

7. An electronic device comprising a battery pack, the battery pack comprising:
a battery case;
a battery housed in the battery case, the battery being configured of a pouch type cell having a first plane and a second plane disposed on an opposite side of the first plane; and
an adhesive layer arranged between at least one of the first plane and the second plane of the battery and an inner surface of the battery case, the adhesive layer being arranged in a shape of a frame along an outer edge of the battery.

8. A method of producing a battery pack, the method comprising the steps of:
mounting a battery to a bottom case;
arranging a buffer material on a top surface of the battery, and applying an adhesive in a shape of a frame along an outer edge of the buffer material; and
mounting a top case to the bottom case, and bonding the top case to the bottom case by the adhesive to form an adhesive layer.
